(19) United States
(12) Patent Application Publication
(10) Pub. No.: US 2011/0225523 A1
(43) Pub. Date: Sep. 15, 2011

(54) EXTENDING 2D GRAPHICS IN A 3D GUI

(75) Inventors: Philip Steven Newton, Eindhoven (NL); Francesco Scalori, Capolago (CH)

(73) Assignee: KONINKLIJKE PHILIPS ELECTRONICS N.V., Eindhoven (NL)

(21) Appl. No.: 13/130,496

(22) PCT Filed: Nov. 19, 2009
(86) PCT No.: PCT/IB2009/055170

§ 371 Date: May 20, 2011

(30) Foreign Application Priority Data
Nov. 24, 2008 (EP) 08169774.0
Dec. 19, 2008 (EP) 08172352.0

(51) Int. Cl. G06F 3/048

(52) U.S. Cl. 715/762

(57) ABSTRACT

A system of providing a three-dimensional [3D] graphical user interface on a 3D image device (13) is provided for controlling a user device (10) via user control means (15). The user control means are arranged for receiving user actions and generating corresponding control signals. A graphical data structure is provided representing a graphical control element for display in the 3D graphical user interface. The graphical data structure has two dimensional [2D] image data for representing the graphical control element, and also at least one depth parameter for positioning the 2D image data at a depth position in the 3D graphical user interface.

### FIELD OF THE INVENTION

The invention relates to a method of providing a three-dimensional [3D] graphical user interface [GUI] on a 3D image device for controlling a user device via user control means, the user control means being arranged for receiving user actions and generating corresponding control signals.

The invention further relates to a 3D image device for providing a 3D graphical user interface for controlling a user device via user control means, the user control means being arranged for receiving user actions and generating corresponding control signals.

The invention relates to the field of rendering and displaying image data, e.g. video, on a 3D image device and providing a GUI for controlling a user device, e.g. the 3D image device itself or a further user device coupled thereto, by a user who is operating (navigating, selecting, activating, etc) graphical elements in the GUI via user control means like a remote control unit, mouse, joystick, dedicated buttons, cursor control buttons, etc.

### BACKGROUND OF THE INVENTION

Devices for rendering video data are well known, for example video players like DVD players, BD players or set top boxes for rendering digital video signals. The rendering device is commonly used as a source device to be coupled to a display device like a TV set. Image data is transferred from the source device via a suitable interface like HDMI. The user of the video player is provided with a set of user control elements like buttons on a remote control device or virtual buttons and other user controls in a graphical user interface (GUI). The user control elements allow the user to adjust the rendering of the image data in the video player via the GUI.

Currently existing devices are based on two-dimensional (2D) display technology and apply 2D GUI for controlling various functions, e.g. in a mobile phone, or on a 2D PC monitor. Furthermore, 3D graphics systems are being developed. For example, document WO 2008/044191 describes a graphics system for creating 3D graphics data. A graphics stream is formed representing the 3D graphics data. The graphics stream comprises a first segment having 2D graphics data and a second segment comprising a depth map. A display device renders 3D subtitle or graphics images based on the data stream.

### SUMMARY OF THE INVENTION

The development of a 3D GUI requires that the existing 2D elements are recreated as 3D objects, e.g. by adding a depth map. However, creating, processing and handling new 3D objects require a powerful processing environment.

It is an object of the invention to provide a 3D graphical user interface that is less complex.

For this purpose, according to a first aspect of the invention, in the method as described in the opening paragraph, comprises providing a graphical data structure representing a graphical control element for display in the 3D graphical user interface, providing the graphical data structure with two dimensional [2D] image data for representing the graphical control element, and providing the graphical data structure with at least one depth parameter for positioning the 2D image data at a depth position in the 3D graphical user interface.

For this purpose, according to a second aspect of the invention, the 3D image device comprises input means for receiving a graphical data structure representing a graphical control element for display in the 3D graphical user interface, the graphical data structure having two dimensional [2D] image data for representing the graphical control element, and at least one depth parameter, and graphic processor means for processing the graphical data structure for positioning the 2D image data at a depth position in the 3D graphical user interface.

For this purpose, according to a further aspect of the invention, there is provided a graphical data structure representing a graphical control element for display in a three-dimensional [3D] graphical user interface on a 3D image device for controlling a user device via user control means, the user control means being arranged for receiving user actions and generating corresponding control signals, the graphical data structure comprising two dimensional [2D] image data for representing the graphical control element, and at least one depth parameter for positioning the 2D image data at a depth position in the 3D graphical user interface.

For this purpose, according to a further aspect of the invention, there is provided a record carrier comprising image data for providing a three-dimensional [3D] graphical user interface on a 3D image device for controlling a user device via user control means, the user control means being arranged for receiving user actions and generating corresponding control signals, the record carrier comprising a track constituted by physically detectable marks, the marks comprising the image data, the image device being arranged for receiving the image data, the image data comprising a graphical data structure representing a graphical control element for display in the 3D graphical user interface, the graphical data structure comprising two dimensional [2D] image data for representing the graphical control element, and at least one depth parameter for positioning the 2D image data at a depth position in the 3D graphical user interface.

For this purpose, according to a further aspect of the invention, there is provided a computer program product for providing a three-dimensional [3D] graphical user interface on a 3D image device, which program is operative to cause a processor to perform the method as defined above.

The above mentioned aspects constitute a system for providing a three-dimensional graphical user interface. The measures have the effect in the system that the existing 2D graphical data structures are extended by adding the depth parameter. The image data of the graphical data structure has a 2D structure, whereas the added at least one depth parameter allows to position the element in the 3D display at a desired depth level. Moreover the user control means provide the control signals to operate and navigate through the 3D GUI based on the 2D graphical elements poisoned in the 3D GUI space.

The invention is also based on the following recognition. The creation and processing of 3D graphical objects requires substantial processing power, which increases the complexity and price level of the devices. Moreover, there will be a large amount of legacy devices that cannot process or display 3D data at all. The inventors have seen that an effective compatibility can be achieved between the legacy 2D environment and the new 3D systems by providing a GUI that is based on the 2D system, but enhanced with respect to positioning enhanced 2D graphical elements in the 3D space. The enhanced 2D graphical elements allow navigating in that space between such elements.

In an embodiment of the system, the graphical data structure comprises at least one of the following depth parameters:

a depth position for indicating the location of the current graphical control element in the depth direction as an additional argument of a corresponding 2D graphical data structure,

a depth position for indicating the location of the current graphical control element in the depth direction as an additional coordinate of a colour model of a corresponding 2D graphical data structure.

The effect is that the depth parameter is added to the 2D structure in a way that is compatible with existing 2D systems. This has the advantage that
such legacy can ignore the added parameter, whereas the enhanced system can apply the added depth parameter for generating the 3D GUI.

In an embodiment of the system, the graphical data structure comprises a 3D navigation indicator indicating that 3D navigation in the 3D graphical user interface is enabled with respect to the graphical data structure. The effect is that in the enhanced system, the navigation indicator indicates if it contains a valid value in the respective field of the graphical data structure of the depth parameter, and further depth parameters for navigation. This has the advantage that it is easily detected if the graphical data structure is suitable for the 3D GUI.

Further preferred embodiments of the device and method according to the invention are given in the appended claims, disclosure of which is incorporated herein by reference.

### BRIEF DESCRIPTION OF THE DRAWINGS

These and other aspects of the invention will be apparent from and elucidated further with reference to the embodiments described by way of example in the following description and with reference to the accompanying drawings, in which

FIG. 1 shows system for providing a 3D graphical user interface,

FIG. 2 shows an example of image data,

FIG. 3 shows a section of an interactive composition structure,

FIG. 4 shows a section of an interactive composition structure having a 3D navigation indicator,

FIG. 5 shows a graphical control element,

FIG. 6 shows a 3D enhanced graphical control element,

FIG. 7 shows a 3D button structure,

FIG. 8 shows a representation of a “dummy” button structure carrying 3D parameters,

FIG. 9 shows a key events table,

FIG. 10 shows a Six DOF Event class and the AWTEvent hierarchy,

FIG. 11 shows a Java AWT component class tree,

FIG. 12 shows extension to the Component class to include depth,

FIG. 13 shows extension to the LayoutManager class to include depth,

FIG. 14 shows an example of the Component class extended to include depth,

FIG. 15 shows an example of the LayoutManager class extended to include depth,

FIG. 16 shows an extension to the Graphics class to include depth,

FIG. 17 shows Extension to the Color class to include depth,

FIG. 18 shows an example of the Graphics class extended to include depth,

FIG. 19 shows an example of the Color class extended to include depth, and

FIG. 20 shows a graphical processor system.

In the Figures, elements which correspond to elements already described have the same reference numerals.

### DETAILED DESCRIPTION OF EMBODIMENTS

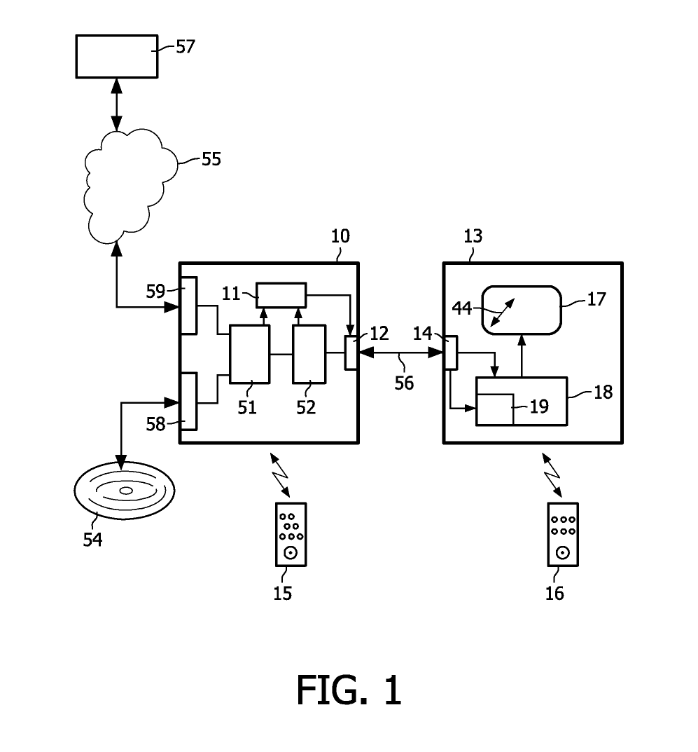

FIG. 1 shows a system for providing a three-dimensional [3D] graphical user interface. The system may render image data, such as video, graphics or other visual information. A 3D image device 10 is coupled as a source device to transfer data to a 3D display device 13. It is noted that the devices may also be combined in a single unit. The 3D image device has an input unit 51 for receiving image information. For example the input unit device may include an optical disc unit 58 for retrieving various types of image information from an optical record carrier 54 like a DVD or BluRay disc. Alternatively, the input unit may include a network interface unit 59 for coupling to a network 55, for example the internet or a broadcast network. Image data may be retrieved from a remote media server 57.

The 3D image device has a processing unit 52 coupled to the input unit 51 for processing the image information for generating transfer information 56 to be transferred via an output unit 12 to the display device. The processing unit 52 is arranged for generating the image data included in the transfer information 56 for display on the 3D display device 13. The 3D image device is provided with user control elements, now called first user control elements 15, for controlling various functions, e.g. display parameters of the image data, such as contrast or color parameter. In particular the user control unit generates signals in response to receiving user actions, e.g. pushing a button, and generating corresponding control signals. The user control elements as such are well known, and may include a remote control unit having various buttons and/or cursor control functions to control the various functions of the 3D image device, such as playback and recording functions, and for operating graphical control elements in a graphical user interface (GUI). The processing unit 52 has circuits for processing the source image data for providing the image data to the output unit 12. The processing unit 52 may have a GUI unit for generating the image data of the GUI, and for positioning the enhanced graphical control elements in the GUI as further described below.

The 3D image device may have a data generator unit (11) for providing a graphical data structure representing a graphical control element for display in the 3D graphical user interface. The unit provides the graphical data structure with two dimensional [2D] image data for representing the graphical control element, and further provides the graphical data structure with at least one depth parameter for positioning the 2D image data at a depth position in the 3D graphical user interface.

The 3D display device 13 is for displaying image data. The device has an input unit 14 for receiving the transfer information 56 including image data transferred from a source device like the 3D image device 10. The 3D display device is provided with user control elements, now called second user control elements 16, for setting display parameters of the display, such as contrast or color parameters. The transferred image data is processed in processing unit 18

The processing unit 18 may have a GUI unit 19 for generating the image data of the GUI, and for positioning the enhanced graphical control elements in the GUI as further described below. The GUI unit 19 receives the graphical data structure via the input unit 14.

The 3D display device has a display 17 for displaying the processed image data, for example a 3D enhanced LCD or plasma screen, or may cooperate with viewing equipment like special goggles, known as such. Hence the display of image data is performed in 3D and includes displaying a 3D GUI as processed in either the source device (e.g. optical disc player 11) or the 3D display device itself.

FIG. 1 further shows the record carrier 54 as a carrier of the image data. The record carrier may for example be a magnetic carrier like a hard disk, or an optical disc. The record carrier is disc-shaped and has a track and a central hole. The track, constituted by a series of physically detectable marks, is arranged in accordance with a spiral or concentric pattern of turns constituting substantially parallel tracks on an information layer. The record carrier may be optically readable, called an optical disc, e.g. a CD, DVD or BD (Blue-ray Disc). The information is represented on the information layer by the optically detectable marks along the track, e.g. pits and lands. The track structure also comprises position information, e.g. headers and addresses, for indication the location of units of information, usually called information blocks. The record carrier 54 carries information representing digitally encoded image data like video, for example encoded according to the MPEG2 encoding system, in a predefined recording format like the DVD or BD format. For accommodating the three-dimensional graphical user interface as proposed the marks in the track of the record carrier also embody the graphical data structure.

In case of BD systems, further details can be found in the publicly available technical white papers “Blu-ray Disc Format General August 2004” and “Blu-ray Disc 1.C Physical Format Specifications for BD-ROM November, 2005”, published by the Blu-Ray Disc association (http://www.bluraydisc.com).

In the following, when referring to the BD application format, we refer specifically to the application formats as disclosed in the US application No. 2006-0110111 (Attorney docket NL021359) and in white paper “Blu-ray Disc Format 2.B Audio Visual Application Format Specifications for BD-ROM, March 2005” as published by the Blu-ray Disc Association.

It is knows that BD systems also provide a fully programmable application environment with network connectivity thereby enabling the Content Provider to create interactive content. This mode is based on the Java™ ( )3 platform and is known as “BD-J”. BD-J defines a subset of the Digital Video Broadcasting (DVB)—Multimedia Home Platform (MHP) Specification 1.0, publicly available as ETSI TS 101 812. An example of a Blu-Ray player is the Sony Playstation 3™, as sold by the Sony Corporation.

The 3D image system is arranged for displaying three dimensional (3D) image data on a 3D image display. Thereto the image data includes depth information for displaying on a 3D display device. Referring to the system described with reference to FIG. 1, the display device 53 may be a stereoscopic display, having a display depth range indicated by arrow 44. The 3D image information may be retrieved from an optical record carrier 54 enhanced to contain 3D image data. Via the internet 3D image information may be retrieved from the remote media server 57.

The following section provides an overview of three-dimensional displays and perception of depth by humans. 3D displays differ from 2D displays in the sense that they can provide a more vivid perception of depth. This is achieved because they provide more depth cues then 2D displays which can only show monocular depth cues and cues based on motion.

Monocular (or static) depth cues can be obtained from a static image using a single eye. Painters often use monocular cues to create a sense of depth in their paintings. These cues include relative size, height relative to the horizon, occlusion, perspective, texture gradients, and lighting/shadows. Oculomotor cues are depth cues derived from tension in the muscles of a viewers eyes. The eyes have muscles for rotating the eyes as well as for stretching the eye lens. The stretching and relaxing of the eye lens is called accommodation and is done when focusing on a image. The amount of stretching or relaxing of the lens muscles provides a cue for how far or close an object is. Rotation of the eyes is done such that both eyes focus on the same object, which is called convergence. Finally motion parallax is the effect that objects close to a viewer appear to move faster then objects further away.

Binocular disparity is a depth cue which is derived from the fact that both our eyes see a slightly different image. Monocular depth cues can be and are used in any 2D visual display type. To re-create binocular disparity in a display requires that the display can segment the view for the left- and right eye such that each sees a slightly different image on the display. Displays that can re-create binocular disparity are special displays which we will refer to as 3D or stereoscopic displays. The 3D displays are able to display images along a depth dimension actually perceived by the human eyes, called a 3D display having display depth range in this document. Hence 3D displays provide a different view to the left- and right eye.

3D displays which can provide two different views have been around for a long time. Most of these were based on using glasses to separate the left- and right eye view. Now with the advancement of display technology new displays have entered the market which can provide a stereo view without using glasses. These displays are called auto-stereoscopic displays.

A first approach is based on LCD displays that allow the user to see stereo video without glasses. These are based on either of two techniques, the lenticular screen and the barrier displays. With the lenticular display, the LCD is covered by a sheet of lenticular lenses. These lenses diffract the light from the display such that the left- and right eye receive light from different pixels. This allows two different images one for the left- and one for the right eye view to be displayed.

An alternative to the lenticular screen is the Barrier display, which uses a parallax barrier behind the LCD and in front the backlight to separate the light from pixels in the LCD. The barrier is such that from a set position in front of the screen, the left eye sees different pixels then the right eye. A problem with the barrier display is loss in brightness and resolution but also a very narrow viewing angle. This makes it less attractive as a living room TV compared to the lenticular screen, which for example has 9 views and multiple viewing zones.

A further approach is still based on using shutter-glasses in combination with high-resolution beamers that can display frames at a high refresh rate (e.g. 120 Hz). The high refresh rate is required because with the shutter glasses method the left and right eye view are alternately displayed. For the viewer wearing the glasses perceives stereo video at 60 Hz. The shutter-glasses method allows for a high quality video and great level of depth.

The auto stereoscopic displays and the shutter glasses method do both suffer from accommodation-convergence mismatch. This does limit the amount of depth and the time that can be comfortable viewed using these devices. There are other display technologies, such as holographic- and volumetric displays, which do not suffer from this problem. It is noted that the current invention may be used for any type of 3D display that has a depth range.

Image data for the 3D displays is assumed to be available as electronic, usually digital, data. The current invention relates to such image data and manipulates the image data in the digital domain. The image data, when transferred from a source, may already contain 3D information, e.g. by using dual cameras, or a dedicated preprocessing system may be involved to (re-)create the 3D information from 2D images. Image data may be static like slides, or may include moving video like movies. Other image data, usually called graphical data, may be available as stored objects or generated on the fly as required by an application. For example user control information like menus, navigation items or text and help annotations may be added to other image data.

There are many different ways in which stereo images may be formatted, called a 3D image format. Some formats are based on using a 2D channel to also carry the stereo information. For example the left and right view can be interlaced or can be placed side by side and above and under. These methods sacrifice resolution to carry the stereo information. Another option is to sacrifice color, this approach is called anaglyphic stereo. Anaglyphic stereo uses spectral multiplexing which is based on displaying two separate, overlaid images in complementary colors. By using glasses with colored filters each eye only sees the image of the same color as of the filter in front of that eye. So for example the right eye only sees the red image and the left eye only the green image.

A different 3D format is based on two views using a 2D image and an additional depth image, a so called depth map, which conveys information about the depth of objects in the 2D image. The format called image+depth is different in that it is a combination of a 2D image with a so called “depth”, or disparity map. This is a gray scale image, whereby the gray scale value of a pixel indicates the amount of disparity (or depth in case of a depth map) for the corresponding pixel in the associated 2D image. The display device uses the disparity or depth map to calculate the additional views taking the 2D image as input. This may be done in a variety of ways, in the simplest form it is a matter of shifting pixels to the left or right dependent on the disparity value associated to those pixels. The paper entitled “Depth image based rendering, compression and transmission for a new approach on 3D TV” by Christoph Fen gives an excellent overview of the technology (see http://iphome.hhi.de/fehn/Publications/fehn_EI2004.pdf).

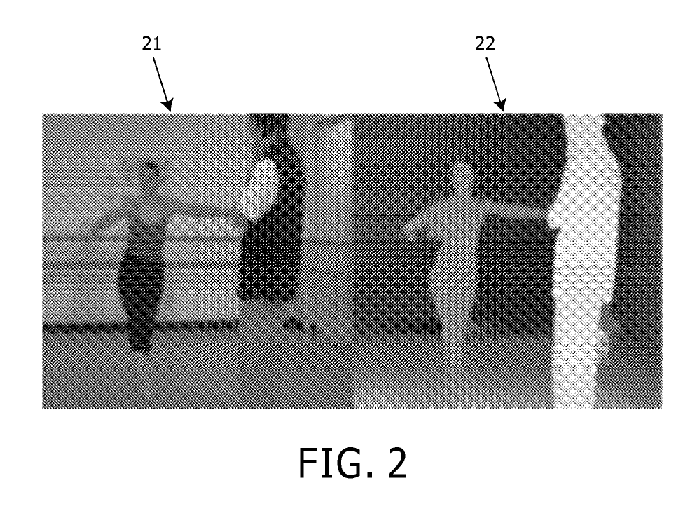

FIG. 2 shows an example of image data. The left part of the image data is a 2D image 21, usually in color, and the right part of the image data is a depth map 22. The 2D image information may be represented in any suitable image format. The depth map information may be an additional data stream having a depth value for each pixel, possibly at a reduced resolution compared to the 2D image. In the depth map grey scale values indicate the depth of the associated pixel in the 2D image. White indicates close to the viewer, and black indicates a large depth far from the viewer. A 3D display can calculate the additional view required for stereo by using the depth value from the depth map and by calculating required pixel transformations. Occlusions may be solved using estimation or hole filling techniques. Further maps may be added to the image and depth map format, like an occlusion map, a parallax map and/or a transparency map for transparent objects moving in front of a background.

Adding stereo to video also impacts the format of the video when it is sent from a player device, such as a Blu-ray disc player, to a stereo display. In the 2D case only a 2D video stream is sent (decoded picture data). With stereo video this increases as now a second stream must be sent containing the second view (for stereo) or a depth map. This could double the required bitrate on the electrical interface. A different approach is to sacrifice resolution and format the stream such that the second view or the depth map are interlaced or placed side by side with the 2D video. FIG. 2 shows an example of how this could be done for transmitting 2D data and a depth map. When overlaying graphics on video, further separate data streams may be used.

The 3D image system as proposed may transfer image data including the graphical data structure via a suitable digital interface. When a playback device—typically a BD player—retrieves or generates the graphical data structure detects such a mask, it transmits the graphical data structure with the image data over a video interface such as the well known HDMI interface (e.g. see “High Definition Multimedia Interface Specification Version 1.3a of Nov. 10, 2006).

The main idea of the 3D image system as described here represents a general solution to the problems stated in the above. The detailed description below is an example only based on the specific case of Blu-ray Disc (BD) playback and using Java programming examples. The BD hierarchical image data structure for storing audio video data (AV data) is composed of Titles, Movie Objects, Play Lists, Play Items and Clips. A user interface is based on an Index Table allowing to navigate between various titles and menus. The image data structure of BD includes the graphical elements to generate the graphical user interface. The image data structure may be enhanced to a 3D GUI by including further control data to represent the graphical data structure as described below.

An example of a graphical user interface (GUI) is described below. It is to be noted that in this document the 3D GUI is used as a denomination for any interactive video or image content, like video, movies, games, etc, which presents 3D image data in combination with graphical elements that the user may interact with in any way, e.g. select, move, modify, activate, press, cross out, etc. Any function may be coupled to such elements, e.g. none at all, a function only within the interface itself like highlighting, a function of the displaying device like starting a movie, and/or functions of other devices, e.g. a home alarm system or a microwave oven.

The BD Publishing format defines a complete application environment for content authors to create an interactive movie experience. Part of this is the system to create menus and buttons. This is based on using bitmap images (i.e. 2D image data) for the menus and buttons and composition information that allows the menu's and buttons to be animated. The composition information may be called composition element or segment, and is an example of the proposed graphical data structure. A typical example of user interaction and a GUI is when a user selects a button in a menu, the state and appearance of the button changes. This can be taken even further into all kinds of animations and content adaptations as the Blu-ray Disc specification supports the Java programming language with a large set of libraries that allow a content creator to control all the features of the system.

Currently the BD provides two mechanisms for a content author to create user selection menus. One method is to use the predefined HDMV interactive graphics specification, the other is through the use of Java language and application programming interfaces.

The HDMV interactive graphics specification is based on a MPEG-2 elementary stream that contains run length encoded bitmap graphics. In addition in BD metadata structures allow a content author to specify animation effects and navigation commands that are tied to the graphics objects in the stream. Graphical objects that have a navigation command associated to them are referred to as (menu) buttons. The metadata structures that define the animation effects and navigation commands associated to buttons are called interactive composition structures.

HDMV is designed on the basis of the use of a traditional remote control, e.g. unit 15 as shown in FIG. 1, that sends a stream of key events instead of position information. There is no free moving cursor available. To solve this we propose a mapping scheme that maps the change of the position of the input device to a user operation. For this purpose we define two new interactive user operations a Move_Forward Selected_button and a Move_Backward-Selected_button. A change in position to the back, away from the screen generates one Move_Backward-Selected_button operation to be called, a change in position towards the screen generates one forward selected_button user operation.

Java is a programming environment using the Java language from Sun Microsystems with a set of libraries based on the DVB-GEM standard (Digital Video Broadcasting (DVB)-Globally Executable MHP (GEM)). More information on the Java programming language can be found at http://java.sun.com/ and the GEM and MHP specifications are available from ETSI (www.etsi.org). Amongst the set of libraries available there is a set that provides programmers access to functions to create a user interface with menus and buttons and other GUI elements.

In an embodiment the interactive composition segment known from BD is enhanced and extended into two types of interactive graphical data structure for 3D. One example of the graphical data structure relies on using existing input devices such as the arrow keys to navigate the menu. A further example allows the use of input devices that allow navigating also in depth. The first interactive composition graphical data structure is completely backwards compatible and may reference graphics objects that have different “depth” positions but it does not provide additional structures for input devices that support additional keys for navigating in the depth or “z-direction”. The second interactive composition graphical data structure for 3D is similar to the first composition object but is extended to allow for input devices that provide “z-direction” input and is not compatible with existing players.

In addition an extended button structure is provided for the interactive composition graphical data structure for 3D such that it contains an entry for the position in the “z-direction” or depth of the button, and an identifier for indicating buttons that are lower or higher in depth than the currently selected button. This allows the user to use a button on a remote to switch selection between buttons that lie at a different depth position.

For the Java programming environment we add an additional library that includes a user interface component that extends the Java interface such that it becomes possible to navigate in the depth dimension. Furthermore two new user operations and related key events are provided that indicate when a user has pressed a key on the remote to navigate in the depth direction.

The advantages of these changes it is possible for the content author to create simple 3D user interfaces and allow the user using an appropriate input device to navigate the interface without introducing a large amount of technical complexity to the implementation of the player device.

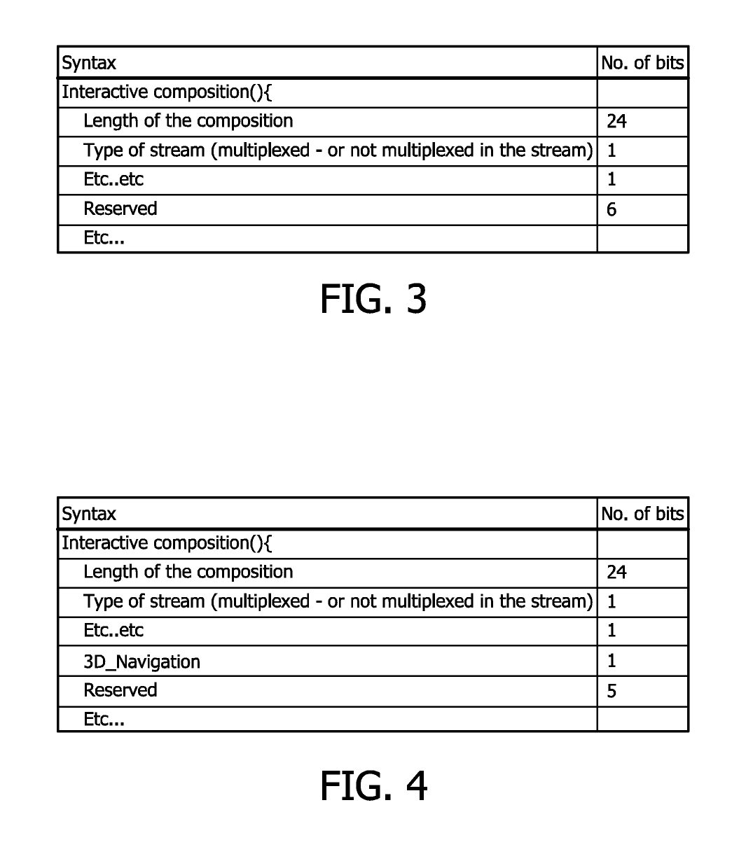

FIG. 3 shows a section of an interactive composition structure. The graphical data structure in is used in the Blu-ray Disc. The fourth field in this table is reserved, it was inserted for byte alignment. The size is 6 bits and we use 1 bit of the 6 to add an additional field that indicates whether or not the interactive composition supports 3D navigation.

FIG. 4 shows a section of an interactive composition structure having a 3D navigation indicator (named 3D_Navigation). This field indicates whether the Interactive composition supports 3D navigation or not. The flag of one bit (1_{b}) indicates 3D (3-direction of Freedom [DOF], x, y and z) navigation is supported, 0_{b} indicates only 2D navigation (2-DOF).

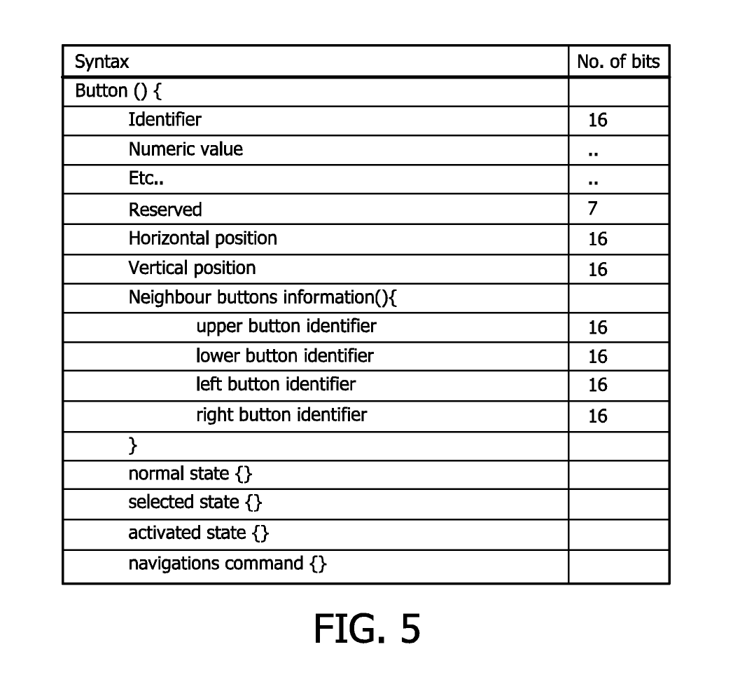

FIG. 5 shows a graphical control element. The table shows a button structure used in BD in a simplified representation.

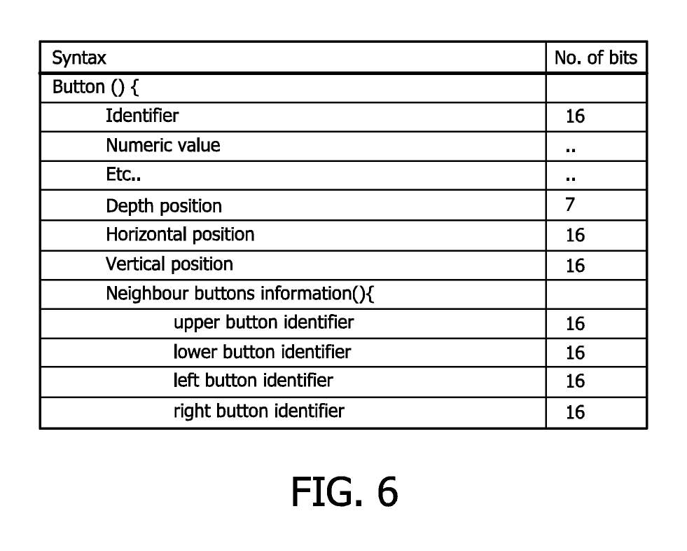

FIG. 6 shows a 3D enhanced graphical control element. The table shows the version of the button structure extended for menu's that consist of 3D graphical objects but that do not use additional input means to navigate the menu. Here the reserved 7 bits are used to indicate a depth position of the button, using a 2-DOF input device such as 4 arrow keys on a remote allows the user to navigate between buttons that are located at different depth positions. For example the up-arrow key may select a button that is positioned further away from the viewer, whilst the down-arrow key is used to select a button that is closer to the viewer. It is noted that typically 8 bits (255 values) are used to indicate depth, but now there are only 7 available so we use the 7 bits as the MS-bits of a 8 bit value. Other mappings are also possible.

By adding a depth position to the button structure the content author can position buttons at different depths and create a z-ordering between them, whereby (parts of) one button overlaps over another. For example when a user selects a button that is not in front, it moves to the front to show the complete button and then if the users wishes to continue he may press the OK or enter key to select the action associated to that button.

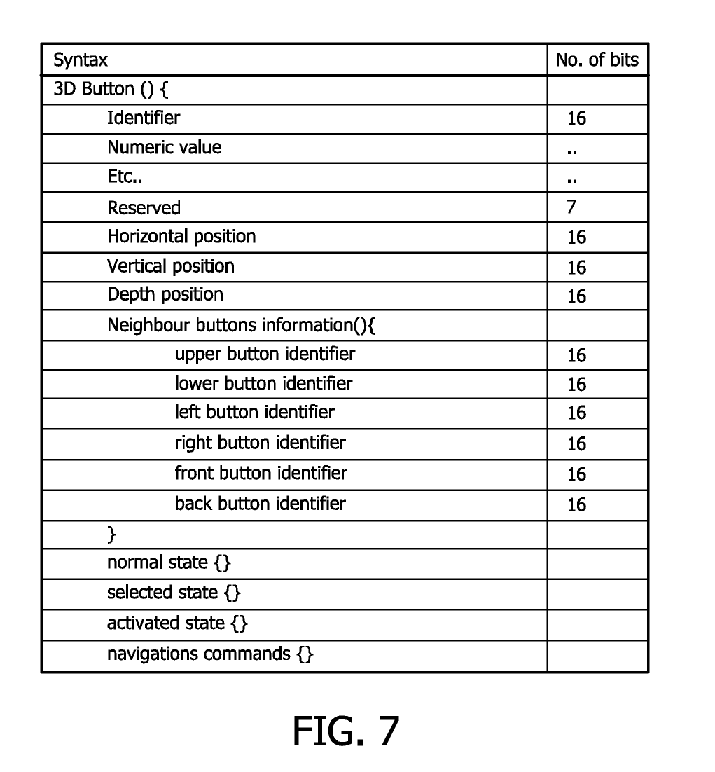

FIG. 7 shows a 3D button structure. The table is extended to allow input from a 3 DOF device and so provide complete 3D navigation. This button structure will be used in the interactive composition when the 3D_Navigation field indicated in the table of FIG. 6 is set to 1_{b}. As there are not enough reserved fields in the existing button structure we have defined a new structure which is not compatible with existing devices.

The fields added are a depth position and a front- and back button identifier. Depth position is a 16-bit value to indicate together with the horizontal and vertical entries the position in 3D space. We used 16 bits to match with the other position parameters, in practice les bits would suffice but using 16 bits creates room for future systems at little cost.

The front- and back button identifier fields are used to indicate which buttons are located in front or behind this button and that should be selected when the user navigates in the depth or so called “z-direction” i.e. away- or towards the screen.

The front button identifier is an example of a front control parameter for indicating a further graphical control element located in front of the current graphical control element, whereas the back button identifier is an example of a back control parameter for indicating a further graphical control element located behind the current graphical control element.

So far we have discussed the preferred solution for extending the Blu-ray disc HDMV interactive graphics for 3D that allows a content author to use two methods, one that is backwards compatible but only supports 2-DOF navigation and one that is not compatible, but is more future proof and supports 3-DOF navigation.

If compatibility is important then there are also other solutions but these sacrifice some amount of functionality. As was shown in FIG. 5 the button structure has 7 reserved bits, these could be used both to indicate the depth position of a button and identifiers for buttons in front or behind this button. For example 3 bits may be used to indicate the depth position; this allows the content author to indicate 8 levels in depth. The remaining 4 bits could be used as identifiers allowing for four buttons behind or in front. The approach could be used with some of the other reserved bits in the button structure, but these are less suitable as they are part of other fields that semantically are not consistent with the proposed new values.

In an embodiment, alternative to using the reserved bits, a “dummy” button is created. This button has no visual component, no navigational commands and is tied to a “real” button. It is used solely to indicate the button depth and behind- and in front button identifiers.

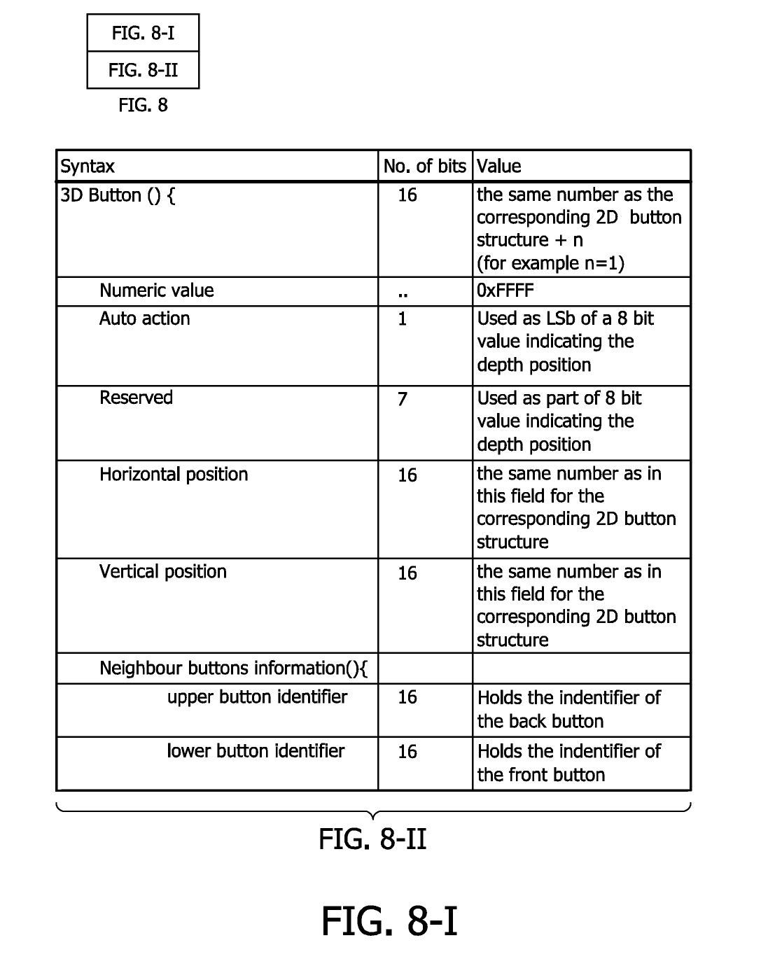

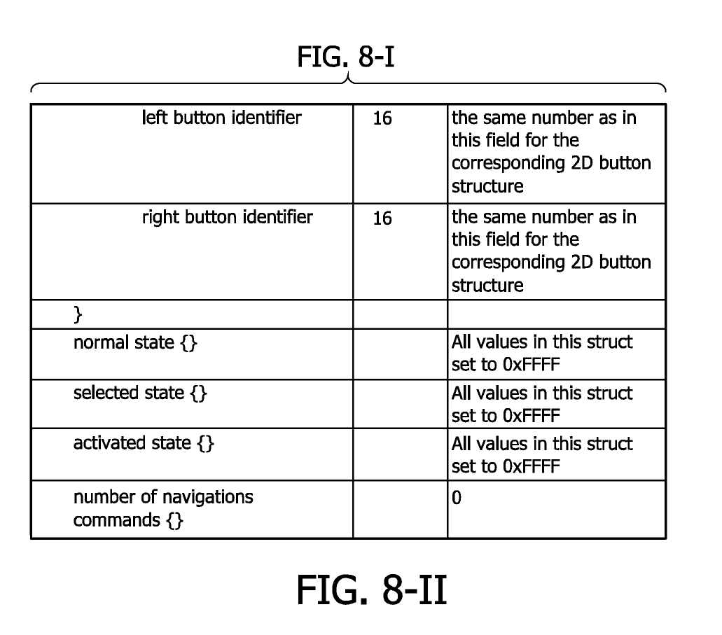

FIG. 8 shows a representation of a “dummy” button structure carrying 3D parameters. The table shows an example of a “dummy” button that is used to carry the 3D button parameters. The identifier of the “dummy” button is such that it can be associated with the corresponding “real” 2D button. Furthermore the reserved 7 bits optionally together with 1 bit of the preceding entry (auto action flag) are used to indicate the depth position of the button. The horizontal and vertical position fields are the same as for the associated 2D button. The upper- and lower button identifiers are used to carry the identifiers for the back and front buttons respectively.

The normal-, selected- and activated state entries normally are used to reference graphical objects that represent the button. When there are no graphical objects associated to a button the values according to the standard should be set to 0xFFFF.

For the BD-Java environment the solutions are somewhat different as BD-java is a programming environment that does not rely on static data structures but rather is based on libraries of functions that perform a set of operations. The basic graphical user interface element is java.awt.Component class. This class is the basic super class of all user interface related items in the java.awt library, such as buttons, textfields etc. The full specification can be obtained from Sun at www.java.sun.com (http://java.sun.com/javame/reference/apis.jsp).

The following section regarding describes extension of Java 2D graphics to include depth. It is described how to extend the java.awt libraries to allow positioning of interactive graphics objects in 3D space. In addition to this we define new user events to also allow 6 DOF navigation to all the user interface elements in the Java.awt libraries.

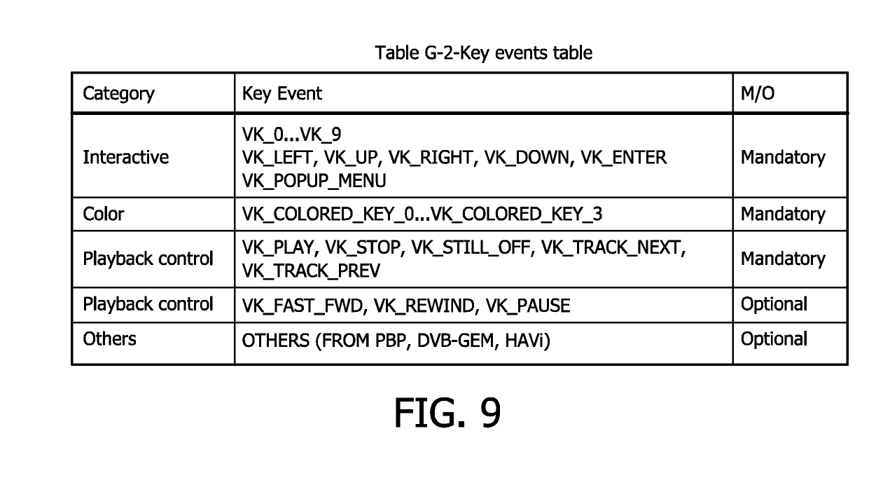

FIG. 9 shows a key events table. A number of possible key events are defined for the Blu-ray Disc. These are extended to include key events in the depth direction. VK_FORWARD refers to when a key is pressed intended to move towards the screen, while VK_BACKWARD indicates that the key corresponding to the direction away from the screen was pushed.

Corresponding User Operations are also defined: Move Forward Selected Button and Move backward Selected Button. This extension to Key Events and User Operations allows to create Java-based interactive applications on the disc whereby users can navigate among multiple buttons in the depth direction, going from the most in front buttons towards the ones further away inside the screen.

In order to support 6 DOF input devices two possibilities exist. The first is to extend the InputEvent class to support 6 DOF kinds of events.

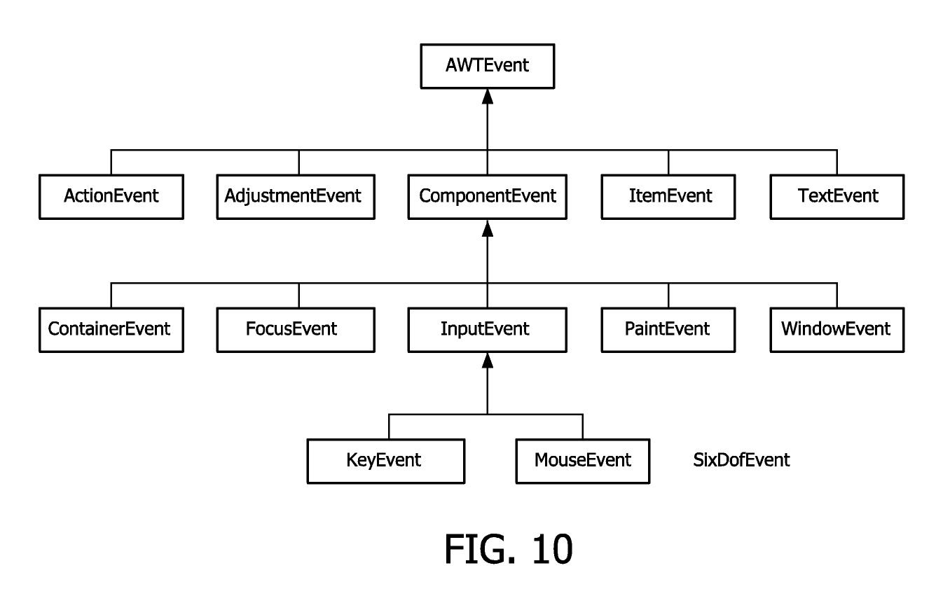

FIG. 10 shows a Six DOF Event class and the AWTEvent hierarchy. The Figure shows the various pre-existing events, and an additional Six DOF Event that represents an event from a 6 DOF input device.

Below is the simplest definition of the SixDofEvent class. It describes position and orientation, including the rotation movements roll, yaw and pitch, of the device when the event—e.g. a movement, a button click—was fired.

```
public class SixDofEvent extends java.awt.InputEvent
{
public SixDofEvent (Component source, int id, long when,
  int modifiers, double x, double y, double z, double roll,
  double yaw, double pitch, int clickCount) {. . .}
public double getX ( ) {. . .}
public double getY ( ) {. . .}
public double getZ ( ) {. . .}
public double getRoll ( ) {. . .}
public double getYaw ( ) {. . .}
public double getPitch ( ) {. . .}
}
```

These events are generated when an input device allowing 6 DOF is moved or a button on the device is clicked. Applications interested in controlling input devices need to be registered as SixDofEventListener. These need to specify the behaviour they want to have when the corresponding event is fired, based on the current position and orientation of the input device.

public interface SixDofEventListener extends java.util.EventListener
{
public void deviceMoved (SixDofEvent e);
public void deviceRotated (SixDofEvent e);
public void deviceButton1Selected (SixDofEvent e);
public void deviceButton2Selected (SixDofEvent e);
}

Alternatively the more complex approach inspired by Java 3D can be followed. Support for 6 DOF is enabled through the Sensor class, which allows applications to read the last N sampled values of the position, orientation and buttons state of the input device. Position and orientation are described by means of a Transform3D object, i.e. by means of a 3×3 rotation matrix, a translation vector and a scale factor.
public Transform3D (Matrix3d m1, Vector3d t1, double s)
These values can be used by applications—next to selecting buttons in a three dimensional space—also e.g., to modify the viewpoint of the rendered scene, mimicking what happens in reality when the user moves his head to look around objects.

Java graphical applications may use standard Java libraries. These comprise, among others, the Abstract Windowing Toolkit (AWT), which provides basic facilities for creating graphical user interfaces (e.g. a “Print” button) and for drawing graphics directly on some surface (e.g. some text). For developing user interfaces, various widgets, called components, are available that allow to create windows, dialogues, buttons, checkboxes, scrolling lists, scrollbars, text areas, etc. AWT provides also various methods that make programmers able to draw different shapes (e.g. lines, rectangles, circles, free text, etc.) directly on previously created canvases, using the currently selected colour, font, and other attributes. Currently all this is in 2D and some extension is needed to add the third dimension to Java graphics.

Enhancing 2D Java graphics towards the third dimension may be done by creating 3D graphics objects and place them in a 3D space, choose a camera viewpoint and render the scene so composed. This is a completely different model than 2D graphics, requires to add a separate library beside the one for drawing in 2D and can be significantly more computationally intensive, although the quality and programming flexibility can reach higher levels.

In an embodiment according to the current invention the current 2D graphics model is extended with the capability to utilize depth information. Instead of forcing programmers to start thinking in a completely different mindset, the already existing widgets and drawing methods are adapted to give them the possibility to specify at which depth graphical objects should appear, whether in front or behind the television screen.

Two alternatives are made available to achieve this:

adapting the various drawing methods (e.g. drawLine, drawRect, etc.) to accept the depth of the object as an additional argument;
extending the colour model with an additional coordinate representing depth; in this way assigning depth to an object would in principle be equivalent to attach a colour to it.

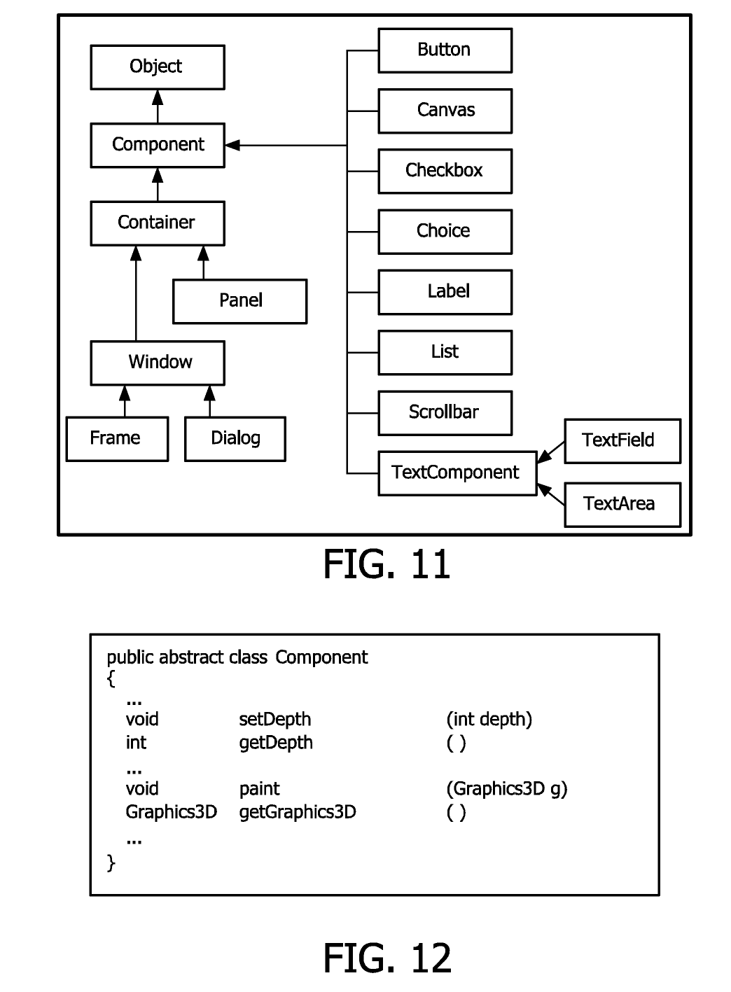

FIG. 11 shows a Java AWT component class tree. Programmers can apply the classes to generate user interfaces. In the following section it is elucidated how to extend these objects with the capability of specifying their depth, which can be achieved by adding the methods to the respective objects.

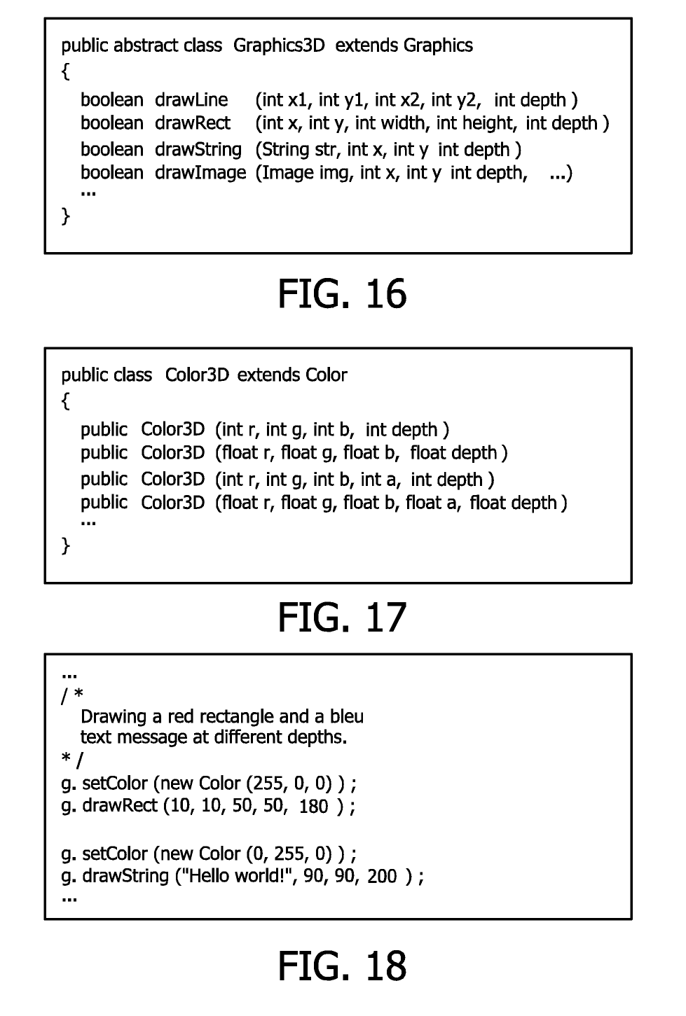

FIG. 12 shows extension to the Component class to include depth. The Figure shows a method to add to a class, and by doing so all the child classes inherently allow to specify at which depth they will appear. Moreover the paint( ) method, which is called when the contents of the component needs to be painted, should be extended with the third dimension. Refer to FIG. 16 for the definition of the class Graphics3D.

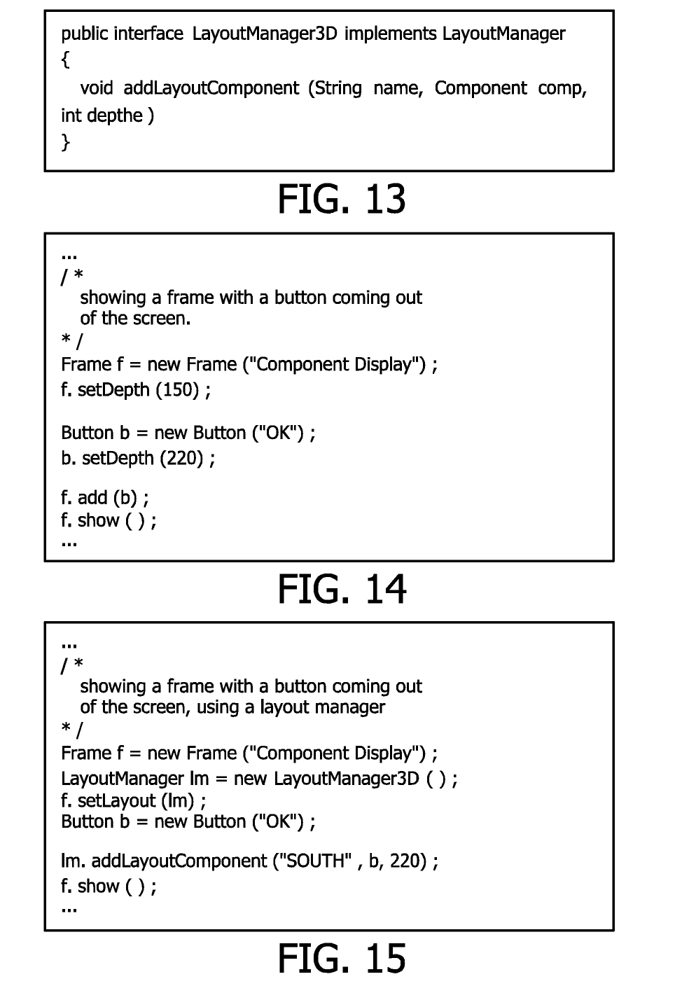

FIG. 13 shows extension to the LayoutManager class to include depth. The Figure shows an alternative to specifying depth as a propriety of each widget, which consists in modifying the LayoutManager interface in order to allow to specify the depth of the component being added to the layout manager in use.

FIG. 14 shows an example of the Component class extended to include depth.

FIG. 15 shows an example of the LayoutManager class extended to include depth. The comparison of the examples in FIGS. 14 and 15 elucidates the embodiments of extension shown in FIGS. 12 and 13.

As mentioned above, the graphics drawing capabilities of the Java standard library need to be enhanced. All the methods in the Graphics class that allow to draw lines, polygons, circles and other various shapes, as well as textual messages and images directly on a painting surface, are to be extended with an indication of their depth.

FIG. 16 shows an extension to the Graphics class to include depth. An additional depth integer parameter has been added.

Alternatively the methods in the Graphics class can be left intact while the color model is upgraded with an additional depth component, similarly to the alpha component which defines the transparency of the object.

FIG. 17 shows Extension to the Color class to include depth. This embodiment requires that changing the depth of the next drawn object is accomplished by setting the current colour with the desired depth value.

FIG. 18 shows an example of the Graphics class extended to include depth.

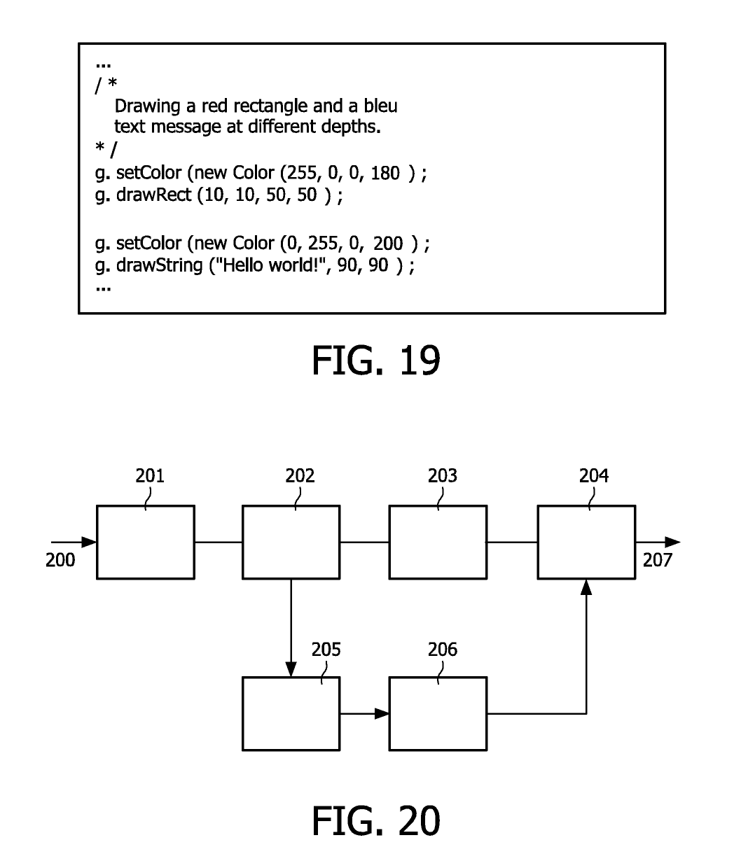

FIG. 19 shows an example of the Color class extended to include depth. The comparison of the examples in FIGS. 18 and 19 elucidates the embodiments of extension shown in FIGS. 16 and 17.

FIG. 20 shows a graphical processor system. The system generates a video output signal 207 based on a encoded video input signal 200. The input signal comprising the image data is received in an input unit 201, which may include an input buffer. The input unit is coupled to a graphics processor 202, which decodes the incoming image data and outputs decoded video objects to an object unit 203, which stores object properties, for example 2D image data retrieved from the enhanced graphical data structure such as bitmaps. The image data from the object unit are used on request by graphics unit 204 which combines various objects to generate the 3D video output signal comprising, for example, the image data for displaying a graphical user interface. The 3D video output signal may be arranged to have various video plains, and contains depth information in any of the formats discussed above. The graphics processor 202 further retrieves and decodes the graphical control structure as discussed above and stores the respective structure data in a composition buffer 205. In particular such data may be called a composition segment which defines how to deal with the image object. The composition unit is coupled to a graphics accelerator 206, which may be used to provide 2D video data. In particular, the depth information included in the enhanced 3D graphical data structure is processed to position the 2D image data (e.g. bitmaps from object unit 203) in a 3D display signal based on the depth parameter(s) now included in the graphical data structure for positioning the 2D image data at a depth position in the 3D graphical user interface.

In overview, the above explores the various extensions that have to be performed to the Java AWT graphics library, in order to enable the development of graphical user interfaces which comprise widgets and objects at different depth levels. This capability can then be utilized in all those standards that support Java based interactive applications, such as Blu-ray (BD-J section) and DVB MHP.

Finally, it is noted that the application is not only limited to 2D+depth formats, but also with stereo+depth formats. In this case depth values can be used to express the intention of the programmer about where graphical objects should appear with respect to how far from the screen plane; this values can then be used to automatically generate an adapted second view from the first, as described in “Bruls F.; Gunnewiek R. K.; “Flexible Stereo 3D Format”; 2007”.

It is to be noted that the invention may be implemented in hardware and/or software, using programmable components. A method for implementing the invention has the processing steps corresponding to the 3D image system elucidated with reference to FIG. 1. A 3D image computer program may have software function for the respective processing steps at the 3D image device; a display computer program may have software function for the respective processing steps at the display device. Such programs may be implemented on a personal computer or on a dedicated video system. Although the invention has been mainly explained by embodiments using optical record carriers or the internet, the invention is also suitable for any image processing environment, like authoring software or broadcasting equipment. Further applications include a 3D personal computer [PC] user interface or 3D media center PC, a 3D mobile player and a 3D mobile phone.

It is noted, that in this document the word ‘comprising’ does not exclude the presence of other elements or steps than those listed and the word ‘a’ or ‘an’ preceding an element does not exclude the presence of a plurality of such elements, that any reference signs do not limit the scope of the claims, that the invention may be implemented by means of both hardware and software, and that several ‘means’ or ‘units’ may be represented by the same item of hardware or software, and a processor may fulfill the function of one or more units, possibly in cooperation with hardware elements. Further, the invention is not limited to the embodiments, and lies in each and every novel feature or combination of features described above.

1. Method of providing a three-dimensional [3D] graphical user interface on a 3D image device for controlling a user device via user control means, the user control means being arranged for receiving user actions and generating corresponding control signals, the method comprising
providing a graphical data structure representing a graphical control element for display in the 3D graphical user interface,
providing the graphical data structure with two dimensional [2D] image data for representing the graphical control element, and
providing the graphical data structure with at least one depth parameter for positioning the 2D image data at a depth position in the 3D graphical user interface.

2. Method as claimed in claim 1, wherein the graphical data structure comprises at least one of the following depth parameters:
a depth position for indicating the location of the current graphical control element in the depth direction as an additional argument of a corresponding 2D graphical data structure,
a depth position for indicating the location of the current graphical control element in the depth direction as an additional coordinate of a colour model of a corresponding 2D graphical data structure.

3. Method as claimed in claim 1, wherein the graphical data structure comprises a 3D navigation indicator indicating that 3D navigation in the 3D graphical user interface is enabled with respect to the graphical data structure.

4. Method as claimed in claim 1, wherein the graphical data structure comprises at least one of the following depth parameters:
a depth position for indicating the location of the current graphical control element in the depth direction,
a front control parameter for indicating a further graphical control element located in front of the current graphical control element,
a back control parameter for indicating a further graphical control element located behind the current graphical control element.

5. Method as claimed in claim 1, wherein the graphical data structure comprises
a 2D button structure for representing a button as the graphical control element in a 2D graphical user interface, and
a dummy button structure comprising said at least one depth parameter for positioning the 2D image data at a depth position in the 3D graphical user interface.

6. Method as claimed in claim 5, wherein the dummy button structure comprises at least one depth parameter in a location that is reserved for a corresponding 2D parameter.

7. Method as claimed in claim 1, wherein the method comprises
converting the control signals into 3D commands for operating the graphical control element in the 3D graphical user interface in dependence of the depth parameter.

8. 3D image device (10) for providing a three-dimensional [3D] graphical user interface for controlling a user device via user control means (15), the user control means being arranged for receiving user actions and generating corresponding control signals, the device comprising
input means (51) for receiving a graphical data structure representing a graphical control element for display in the 3D graphical user interface, the graphical data structure having two dimensional [2D] image data for representing the graphical control element, and at least one depth parameter, and
graphic processor means (52,18) for processing the graphical data structure for positioning the 2D image data at a depth position in the 3D graphical user interface.

9. 3D image device as claimed in claim 8, wherein the input means comprises reading means (58) for retrieving the graphical data structure from a record carrier.

10. 3D image device as claimed in claim 9, wherein the reading means (58) are optical disc reading means.

11. Graphical data structure representing a graphical control element for display in a three-dimensional [3D] graphical user interface on a 3D image device for controlling a user device via user control means, the user control means being arranged for receiving user actions and generating corresponding control signals, the graphical data structure comprising
two dimensional [2D] image data for representing the graphical control element, and
at least one depth parameter for positioning the 2D image data at a depth position in the 3D graphical user interface.

12. Record carrier (54) comprising image data for providing a three-dimensional [3D] graphical user interface on a 3D image device for controlling a user device via user control means, the user control means being arranged for receiving user actions and generating corresponding control signals, the record carrier comprising a track constituted by physically detectable marks, the marks comprising the image data, the image device being arranged for receiving the image data, the image data comprising
a graphical data structure representing a graphical control element for display in the 3D graphical user interface, the graphical data structure comprising
two dimensional [2D] image data for representing the graphical control element, and
at least one depth parameter for positioning the 2D image data at a depth position in the 3D graphical user interface.

13. Computer program product for providing a three-dimensional [3D] graphical user interface on a 3D image device, which program is operative to cause a processor to perform the method as claimed claim 1.
